(19) United States
(12) Patent Application Publication
(10) Pub. No.: US 2007/0028099 A1
(43) Pub. Date: Feb. 1, 2007

(54) Secure multicast transmission

(75) Inventors: Leonid Entin, Modiin (IL); Noam Amram, Holon (IL); Meir Fuchs, Modiin (IL)

Correspondence Address: WOLF, BLOCK, SCHORR & SOLIS-COHEN LLP, 250 PARK AVENUE, NEW YORK, NY, 10177, US

(73) Assignee: Bamboo MediaCasting Ltd., Kfar-Saba (IL)

(21) Appl. No.: 11/375,667

(22) Filed: Mar. 13, 2006

Related U.S. Application Data
(63) Continuation-in-part of application No. PCT/IL04/00806, filed on Sep. 7, 2004.

(30) Foreign Application Priority Data
Sep. 11, 2003 (IL) 157886

(51) Int. Cl. H04L 9/00

(52) U.S. Cl. 713/163

(57) ABSTRACT

A method of multicasting data. The method includes providing a data block for multicasting, generating a plurality of segments that represent the data block, such that a receiver needs to receive fewer than all the generated segments in order to reconstruct the data block, encrypting at least a portion of the generated segments, so as to generate encrypted data units encrypted with a plurality of different keys or encryption methods and transmitting the encrypted data units over one or more multicast channels.

### RELATED APPLICATIONS

The present application is a continuation in part (CIP) of PCT/IL2004/000806 filed on Sep. 7, 2004 and PCT/IL2004/000805, filed on Sep. 7, 2004, which designate the U.S., the disclosures of both of which are incorporated herein by reference.

### FIELD OF THE INVENTION

The present invention relates generally to communication networks and particularly to methods of preventing unauthorized dissemination of multicast data.

### BACKGROUND OF THE INVENTION

Cellular phones can be used for receiving video clips and other data, in addition to their use for point to point telephone communication. Multicasting the data to the cellular phones or to other mobile stations allows efficient use of the available bandwidth, such that large amounts of data can be provided to the cellular phones without requiring prohibitive amounts of bandwidth. In some cases, users are required to subscribe and pay for the multicast data if they desire to receive the data. In order to prevent other cellular phones that were not subscribed to the data from receiving the data without paying, the data is encrypted and only subscribers are provided with the decryption key. A problem arises, however, if one of the subscribers disseminates the key to other users, allowing the other users to decrypt the data without paying. It is noted that while a subscriber could forward the entire data to other users, this would be very costly in cellular networks, generally more than the cost of subscription.

U.S. patent publication 2003/0046539 to Negawa, the disclosure of which is incorporated herein by reference, suggests periodically changing the key and providing the keys to the subscribers on encrypted private unicast channels. This solution, however, is not suitable for a sophisticated disseminating user who continuously provides the keys to other users immediately when the new keys are received.

U.S. patent publication 2002/0039361, to Hawkes et al., the disclosure of which is incorporated herein by reference, suggests supplying each mobile station with a special processing and storage module which is adapted for storing keys and other secret information, without the information being available to the user for dissemination. Such solution requires that all users buy special hardware in order to receive the multicast data and therefore is unpractical.

U.S. patent publication 2002/0138826 to Peterka, the disclosure of which is incorporated herein by reference, suggests transmitting the multicast data in a few copies with different keys. Each copy of the multicast data is provided with a different rate of changing decryption keys. A subscribing user pays for data for a predetermined amount of time and accordingly is provided with a key for a group having a key replacement timing fitting the time for which the user paid. Thus, change of keys is not required when a user leaves the group. However, no method of discouraging sharing of the keys is described.

U.S. patent publication 2002/0136407, to Denning et al., the disclosure of which is incorporated herein by reference, describes a method of encrypting data such that it can be decrypted only if it passed through a predetermined path, at a predetermined location or during a predetermined time range. The sender encrypts the data directed to each location with an encryption key related to the location of the receiver. This method is not suitable for multicast and is not suggested for multicast.

U.S. Pat. No. 5,987,137 to Karppanen et al., the disclosure of which is incorporated herein by reference, describes a method of encryption in which data is encrypted using a key formed of a base key and public information, such as the identity of the base station from which the data is transmitted. This method is claimed to make it harder for an eavesdropper to determine the encryption key.

### SUMMARY OF THE INVENTION

An aspect of some embodiments of the invention relates to a method of multicast delivery of a data file or a data block to receivers. The data block may be a file, a portion thereof or may be a portion of a real time data stream. The method includes encrypting the data file and providing one or more keys required for decrypting the file only after the data is provided to the receiver. Providing the keys only after transmission of the data allows having the receivers request for the keys, so that the requests serve as acknowledgement of receiving the data file. In addition, providing the key only after the data transmission reduces the time available for users to illegally disseminate keys. The term multicast refers in the present application, including the claims, to any transmission to a plurality of receivers, including broadcast to all receivers of a network. In some embodiments of the invention, however, the multicast transmission is not directed to all users but only to subscribers, and methods are used to provide keys only to subscribers and/or to transmit the data only in areas where there are one or more subscribers. Possibly, the multicast data is transmitted on a broadcast channel to all users, but only subscribers can decrypt the content of the transmission.

The provision of the keys may be from a remote unit, e.g., over a wireless transmission link, or may be from a local key generator, for example a secure key provision card, mounted on, embedded in, or otherwise coupled to the receiver, but to which the user of the receiver does not have access.

Optionally, some of the receivers are provided in advance with the one or more keys required for decrypting, in order to reduce the load on a key server that provides the keys immediately after the multicast transmission. In some embodiments of the invention, the receivers that received the keys in advance are requested to acknowledge the receipt of the transmission at a later time (e.g., after 10-60 minutes), for billing purposes.

In some embodiments of the invention, the receivers that receive the keys in advance are selected at least partially randomly, so that it is not possible to plan ahead a scheme of receiving the file without acknowledging the receipt. Alternatively or additionally, the receivers that are provided with the keys before the multicast transmission are chosen based on their acknowledgment history. Optionally, a receiver that did not acknowledge receipt of a previous multicast transmission is not provided the keys before the multicast transmission. Alternatively, each receiver is given a reliability score and the receivers that receive the keys in advance are chosen according to the scores.

In some embodiments of the invention, a set of one or more keys sufficient for decrypting the file as received by only some of the receivers is provided in advance to all the receivers or to all the receivers in a limited location. The one or more keys are optionally provided in a multicast transmission. Only receivers that need keys beyond those provided in advance will request the additional keys from the key server after receiving the file. In some embodiments of the invention, the receivers that require keys beyond those provided in advance, are receivers that change their location between the transmission of the keys and the transmission of the file and/or receivers that changed location during the transmission of the file. Alternatively or additionally, the receivers that require keys beyond those provided in advance, are receivers that received additional keys in advance (e.g., have permanent keys) or that receive supplementary keys in a unicast key transmission before the multicasting of the file.

In some embodiments of the invention, the data file multicast to users includes a non-encrypted preview portion and at least one encrypted portion. The user may view the preview portion and accordingly determine whether to request the key for the encrypted portion. In some embodiments of the invention, the at least one encrypted portion may include a plurality of portions and the user may determine, independently from each other, for which portions to request decryption keys. Optionally, the user may request the key for each portion at different times. Alternatively or additionally, the user may determine whether to request a key for one of the portions based on viewing one or more of the portions for which a key was previously received. Providing a plurality of portions together reduces the amount of signaling required for the delivery of the plurality of portions to the receivers.

An aspect of some embodiments of the invention relates to a method of multicasting a data block to a plurality of receivers. The block is represented by a plurality of data segments which include redundancy, such that the block can be determined in its entirety even if fewer than all the segments are received. It is noted that some of the data segments may be identical. The segments are divided into groups which are encrypted using different keys. In order to decrypt the block, the receiver optionally requests, from a key provider, the keys it needs for the segments it received. The segments are transmitted in a manner such that different receivers receive segments requiring different keys and therefore require different sets of keys to decrypt the segments and reconstruct the block. A receiver requesting the keys cannot generally distribute the keys to other receivers on a large scale, as the keys will not be usable, based on statistical analysis, by more than a few other receivers.

In some embodiments of the invention, the segments are transmitted on a high loss channel (e.g., with a loss rate of at least 10% or even at least 20% of the packets transmitted on the channel, such that different receivers receive different segments due to the losses of the channel. Alternatively or additionally, different portions of the segments are transmitted on different channels (e.g., different time slots, frequencies, codes), and different receivers tune on to different channels. Optionally, receivers may tune on to a single channel during the entire transmission or may switch between channels during the transmission. In some embodiments of the invention, each receiver is preconfigured with one or more channels to which it listens.

Further alternatively or additionally, different segments are transmitted in different regions, from different multicasting points, for example from different base stations of a cellular network. A receiver may optionally regenerate the block using a valid set of segments collected from a plurality of different multicasting points, and is not limited to segments from a single multicasting point. Thus, a receiver moving during the transmission between different multicasting points can use the data received from different multicast points.

The data segments are optionally generated and encrypted at a single source point, and are transmitted from the source point to the multicasting points on respective unicast channels, optionally passing on cables connecting the source point to the multicast points. As the cost of wireless bandwidth is much higher than the cost of terrestrial bandwidth, the additional cost of distributing different segments or different keys to the multicast points by land lines is relatively small.

Alternatively, the segments are not encrypted (or are encrypted using a different method) on their way to the multicasting points, and the encryption is performed by the multicasting points. In this alternative, the segments may be multicast to the multicasting points, over a cabled network or wirelessly using encryption or frequencies not available to the end user, thus reducing the amount of bandwidth used for distributing the data to the multicasting points. Further alternatively, the data is broken up into segments or is generated at the multicasting points or on the way to the multicasting points.

In some embodiments of the invention, the segments representing the block include FEC encrypted segments, such that a receiver collecting a predetermined number (m) of segments out of the (n) transmitted segments can reconstruct the block. Optionally, sub-groups of the FEC segments, including one or more segments, are encrypted with different keys. If many of the receivers receive the block on a high loss rate channel, such that they receive only m or a few more than m segments, the receivers will generally require different sets of keys for decryption.

Optionally, the keys are changed with time, for example after transmission of every few segments. Alternatively, the segments encrypted with same keys are interleaved between segments encrypted with other keys.

In some embodiments of the invention, the encryption segments are smaller than or equal the size of the FEC segments, such that they do not extend beyond the border between two FEC segments. Thus, an error in a transmitted encryption segment affects only a single FEC segment.

The methods for discouraging key sharing of the present invention may optionally be used with substantially any coding method, from very simple methods to very complex methods. It is noted, however, that using the methods of the present invention serves in itself as a relatively high barrier to illegitimate decryption on a large scale and therefore, relatively simple coding methods, such as symmetric encryption may be used.

The methods of the present invention are generally applied to the data itself and not to keys which are used to encrypt the data. Therefore, a user who rightfully receives the keys to the data cannot easily transfer the decrypted data to a different user, as this would require transferring very large amounts of data.

An aspect of some embodiments of the present invention relates to transmitting same multicast data through a plurality of base stations with different encryption for each of the base stations (or group of base stations). The different encryptions require different keys which are not derivable from each other or from a common meta key, using only public information.

In some embodiments of the invention, a mobile station receiving a first portion of the data from a first base station and a second portion of the data from a second base station can reconstruct the data, although the first and second portions were encrypted with different encryptions. The different encryption optionally includes use of a different key and/or a different encryption method. Using different encryption schemes for data transmitted by different base stations, limits the possibility of illegal disseminating of decryption keys, as keys suitable for data of one base station are not suitable for other base stations.

In some embodiments of the invention, some or all of the base stations of the network advertise (e.g., in periodic broadcast or multicast messages) the keys of neighboring base station regions, encrypted with the key (or keys) of the current region. Thus, the movement between regions does not require procedures for receiving the keys of the newly entered region. On the other hand, a receiver normally only receives a limited number of keys of adjacent regions and keys for farther regions preferably cannot be determined from the received keys and public information.

An aspect of some embodiments of the invention relates to monitoring the keys requested by receivers to identify receivers that request keys they do not need, possibly in order to disseminate the keys to other receivers. The monitoring is optionally performed by a remote key server or by a secure key generator coupled to the receiver.

There is therefore provided, in accordance with an embodiment of the invention, a method of multicasting data, comprising providing a data block for multicasting, generating a plurality of segments that represent the data block, such that a receiver needs to receive fewer than all the generated segments in order to reconstruct the data block, encrypting at least a portion of the generated segments, so as to generate encrypted data units encrypted with a plurality of different keys or encryption methods and transmitting the encrypted data units over one or more multicast channels.

Optionally, encrypting data of each segment into a plurality of encrypted data units comprises leaving a portion of each segment not encrypted. Optionally, the non-encrypted portions of the segments are used for transferring preview information. Optionally, the non-encrypted portions are located in different positions in different segments. Alternatively, the non-encrypted portions are located in same positions of substantially all the segments.

There is further provided in accordance with an embodiment of the invention, a method of receiving multicast data over a transmission network, by a mobile station, comprising receiving one or more data units of a data block, from each of a plurality of multicast transmission points, the data units of each transmission point being encrypted using different respective one or more keys, decrypting the data units and reconstructing the data block from the decrypted data units, which were received from the plurality of multicast transmission points.

There is further provided in accordance with an embodiment of the invention, a method of multicasting data, comprising providing a data block for multicasting, generating a plurality of different sets of encrypted segments requiring different sets of decryption keys, to represent the data block, and transmitting each of the different sets of encrypted segments from a different multicast transmission point.

There is further provided in accordance with an embodiment of the invention, a method of disseminating keys for decryption, comprising registering a plurality of receivers as clients of a multicast service of data and providing each receiver with one or more keys required for utilizing the data of the multicast service, responsive to a location of the receiver, such that at least two receivers are provided with different keys. Optionally, the different keys provided to the at least two receivers enable usage of the same data content by all of the at least two receivers. Possibly, the different keys are sufficient to allow usage of all the data of the multicast service. Optionally, the method includes determining for each receiver a parameter of a location in which the receiver is located and wherein providing the keys comprises providing responsive to the parameter of the location of the receiver.

Optionally, data encrypted with the provided keys is transmitted to the receivers in segments with key IDs that identify the keys to be used in their decryption and wherein determining the parameter of the location comprises receiving a key ID which is used only in one or more specific regions. Optionally, determining the parameter and providing the one or more keys responsive to the determined parameter comprises determining a base station to which the client is registered and transmitting the keys by the base station. Optionally, providing the one or more keys comprises providing secondary keys used in decrypting traffic keys which can be used to decrypt the data. Optionally, the method includes providing the traffic keys in multicast or broadcast. Optionally, providing the one or more keys comprises providing traffic keys of the data. Optionally, providing the one or more keys comprises providing different keys in at least ten different geographical regions.

Optionally, the areas of regions in which different keys are provided change dynamically, such that keys provided in different areas at a same time may be the same at a first time point and different at a second time point. Optionally, providing the one or more keys comprises providing the keys after providing all the data for which the keys are to be used. The one or more keys are optionally provided in a unicast session and/or in a broadcast. Optionally, the different keys require separate dissemination to users.

There is further provided in accordance with an embodiment of the invention, a method of multicasting data in a multi-transmission point network, comprising providing a data block for multicasting by the network, encrypting at least a portion of the provided data block, for each of a plurality of transmission points of the multi-transmission-point network, using at least one decryption key, so as to generate one or more encrypted data units for each of the transmission points; and transmitting the encrypted data units from their respective transmission points, the at least one decryption key of at least two of the transmission points are different and require separate dissemination to users.

Optionally, encrypting so as to generate one or more encrypted data units comprises generating a plurality of segments that represent the data block and encrypting at least a portion of the generated segments. Optionally, encrypting at least a portion of the segments comprises encrypting using a symmetric encryption. Optionally, at least some of the transmission points transmit data units representing identical segments encrypted using different keys. Optionally, generating the plurality of segments comprises generating segments that include a portion of the data block. Optionally, encrypting at least a portion of the segments comprises encrypting such that each data unit represents data from a single segment.

Optionally, generating the plurality of segments comprises generating such that a receiver needs to receive fewer than all the generated segments of a single transmission point in order to reconstruct the data block. Optionally, generating the plurality of segments comprises generating forward error correction (FEC) segments. Optionally, generating the FEC segments comprises generating such that any group of up to a predetermined number of non-identical segments can be used to reconstruct the data block.

Optionally, the data units are generated such that a receiver can reconstruct the data block using segments received from two different multicast transmission points and encrypted using different keys. Optionally, transmitting the encrypted data units from their respective transmission points comprises transmitting at substantially the same time. Optionally, the at least one decryption key of at least two of the transmission points are not derivable from a common seed using only publicly available information. Optionally, the method includes receiving, from mobile stations, requests for decryption keys. Optionally, receiving the requests comprises receiving after transmitting the encrypted data units from their respective transmission points. Optionally, the data block comprises data to be displayed to a user.

Optionally, the data block comprises one or more traffic keys to be used in decrypting data. Optionally, the method includes providing keys before or after transmitting the data units, by a management of the network. Optionally, the at least two of the transmission points using different keys that require separate dissemination to users comprise at least ten transmission points. Optionally, at least two of the transmission points use the same keys. Optionally, the transmission points included in a group that use same keys vary dynamically over time. Optionally, the transmission points included in a group that use same keys vary over time during transmission of data units representing a single data block. Optionally, at least one of the transmission points transmits data units of the same block encrypted using a plurality of different keys. Optionally, each transmitted data unit is encrypted with a different key. Optionally, transmitting the encrypted data units comprises transmitting on a lossy channel, having a loss rate of at least 10% of the packets it carries. Optionally, encrypting at least a portion of the generated segments comprises encrypting with a sufficient number of keys, so that given a loss rate of the multicast channels, less than a predetermined percentage of receivers of the data block will be able to use, on the average, the same set of keys for decryption.

Optionally, encrypting at least a portion of the generated segments comprises encrypting with a sufficient number of keys, so that given a loss rate of the multicast channels, less than ten percent of the receivers of the data block will be able to use on the average the same set of keys for decryption. Optionally, the method includes receiving requests for keys required for decryption and keeping track of receivers that request a suspiciously large number of keys or request keys corresponding to non-existent identifications.

Optionally, substantially all the encryption for the plurality of transmission points is performed at a single location. Optionally, the encryption of different segments is performed by different units. Optionally, the method includes transmitting the at least one key of a first transmission point encrypted by a key of a second transmission point, through one of the transmission points. Optionally, transmitting the at least one key of the first transmission point encrypted by a key of a second transmission point comprises transmitting through the second transmission point. Optionally, transmitting the at least one key of the first transmission point encrypted by a key of a second transmission point comprises transmitting through the first transmission point. Optionally, transmitting the at least one key of the first transmission point comprises transmitting on a broadcast channel. Optionally, transmitting the at least one key of the first transmission point comprises transmitting through a first transmission point, keys of a plurality of neighboring transmission points encrypted by the key of the first transmission point.

There is further provided in accordance with an embodiment of the invention, a method of receiving multicast data over a transmission network, by a mobile station, comprising receiving, by a data reception unit of a mobile station, a plurality of data units to be used in reconstructing a data block, from a plurality of transmission points of the network, at least two data units received through different transmission points being encrypted in a manner requiring different keys, for decryption, receiving the different keys required for decrypting the at least two data units, from a unit separate from the data reception unit, decrypting the at least two data units and reconstructing the data block using the decrypted data units.

Optionally, receiving the keys required for decryption comprises receiving from a remote unit. Optionally, receiving the keys required for decryption comprises receiving from a secure unit coupled to the mobile station. Optionally, the different keys required by the at least two data units are not derivable from a same seed using publicly available information. Optionally, reconstructing comprises reconstructing in accordance with a forward error correction FEC scheme.

Optionally, the method includes determining from the received data units identification of the keys required in order to decrypt the data units and requesting the required keys from a key server. Possibly, the identifications of the keys depend, at least partially, on the transmission point through which the data units are received, such that data units transmitted through different transmission points include different key identifications. Optionally, the multicast transmission points comprise base stations and/or one or more DVB-H base stations. Optionally, each of the data units used in reconstructing the data block is decrypted using a separate key.

There is further provided in accordance with an embodiment of the invention, a method of multicasting data, comprising providing a data block for multicasting, generating a plurality of segments that represent the data block, such that a receiver needs to receive fewer than all the generated segments in order to reconstruct the data block, encrypting at least a portion of the generated segments, so as to generate encrypted data units encrypted with a plurality of different keys, which require separate dissemination to users and transmitting the encrypted data units over one or more multicast channels. Optionally, transmitting the encrypted data units comprises transmitting over one or more multicast channels by a single transmitter.

Possibly, the different keys are not derivable from a same seed using only public information. Optionally, each of the plurality of different keys is used for no more than three segments. Optionally, each segment is encrypted using a different key. Optionally, transmitting the encrypted data comprises transmitting over a channel having a loss rate of at least 2%.

There is further provided in accordance with an embodiment of the invention, a mobile station, comprising a receiver adapted to receive data over a wireless connection and a processor adapted to accumulate a plurality of data units received through the receiver from a plurality of different transmission points, which data units include at least two data units received through different transmission points require different keys for decryption, and also adapted to receive the different keys required for decrypting the data units, to decrypt the at least two data units and to reconstruct the data block using the decrypted data units.

Possibly, the mobile station includes a secure card, separate from the processor and having different ease of access by a user of the mobile station, which is adapted to provide the keys to the processor.

There is further provided in accordance with an embodiment of the invention, a method of managing key provision, comprising receiving, from a receiver, a request for keys required in order to decrypt encrypted segments of a plurality of segments representing a data block; and checking whether there is a suspicion that the receiver will disseminate requested keys to other receivers. Possibly, the checking comprises checking whether there is a possibility that the requesting receiver actually needs all the requested keys in the request, for decrypting the data block.

Optionally, the checking comprises checking whether the receiver requested for the data block more keys than the data block requires for decryption. Optionally, the checking comprises checking whether the receiver requested a suspiciously high number of keys. Optionally, each encrypted segment requires a different key for decryption. Optionally, the checking comprises checking whether the receiver requested keys relating to packets transmitted in locations separated by a distance which cannot normally be traveled on the ground during the entire transmission time of the data block. Possibly, the checking comprises checking whether the receiver requested two keys which can only be used for the same data segment with different encryption. Optionally, the checking comprises checking whether the receiver requested more keys relating to segments of a FEC block than required for decoding the FEC block. Optionally, receiving the request comprises receiving by a secure unit coupled to the receiver. Optionally, receiving the request comprises receiving by a unit external to the receiver. Optionally, the method includes not providing the requested keys if the check determined that there is no possibility that the requesting mobile actually needs the keys for the data block. Optionally, the method includes not providing the requested keys if the check determined that there is no possibility that the requesting mobile actually needs the keys for the data block.

There is further provided in accordance with an embodiment of the invention, a method of receiving a data block provided in a multicast transmission, comprising tuning, by a mobile station, onto a multicast channel, receiving a plurality of packets, including at least one encrypted packet, which can be used in reconstructing the data block, on the multicast channel; and receiving at least one key required for decrypting the at least one encrypted packet after receiving sufficient packets for reconstruction of the block.

Optionally, at least ten packets are required for reconstruction of the block. Optionally, receiving the at least one key after receiving sufficient packets for reconstruction of the block comprises receiving substantially all the keys required for the packets after receiving sufficient packets for reconstruction of the block.

Optionally, receiving the at least one key comprises receiving on a unicast connection. Possibly, the key is received from a remote unit. Alternatively, receiving the at least one key comprises receiving from a secure key generator attached to the mobile station. Optionally, the method includes receiving by the secure key generator from a remote unit a seed to be used in generating the at least one key. Optionally, receiving the seed comprises receiving the seed after receiving the packet. Possibly, receiving the seed comprises receiving the seed before receiving the packet. Optionally, receiving the packets comprises receiving packets which represent the block in accordance with a FEC scheme.

Possibly, encrypting at least some of the segments comprises encrypting one or more of the segments utilizing a first key and using at least one other key for at least one other segment. Optionally, the method includes identifying receivers that request a suspiciously large number of keys or request non-existent keys. Optionally, requesting the at least one key is performed only after the receiver determined that a sufficient amount of data was received to allow reconstruction of the data block. Optionally, receiving the at least one encrypted packet comprises receiving a plurality of encrypted packets. Optionally, the plurality of encrypted packets require at least two different keys for decryption.

Optionally, the at least one key is received after receiving a sufficient number of packets for reconstructing the data block. Optionally, the method includes requesting the at least one key after receiving a sufficient number of packets for reconstructing the data block and wherein receiving the at least one key is performed responsive to the requesting. Possibly, the requesting of the at least one key is performed responsive to a user instruction. Optionally, the data block includes a plurality of different portions requiring different keys for decryption. Optionally, the keys required for at least one portion are received after displaying at least one other portion, possibly a portion which was decrypted.

There is further provided in accordance with an embodiment of the invention, a method of multicasting a data block, comprising representing the data block by a plurality of segments, such that fewer than all the segments are required for reconstruction of the block, encrypting at least one of the segments using one or more keys, transmitting the segments in a multicast transmission and providing at least one of a plurality of receivers with one or more decryption keys required for decrypting the transmitted encrypted segments, after a sufficient number of segments required for reconstruction of the block were transmitted.

Optionally, the method includes providing at least one of the receivers with at least one decryption key for the encrypted block, before transmitting the encrypted block. Optionally, the method includes receiving from the at least one receivers provided with the decryption keys before transmitting the encrypted block, acknowledgement messages.

In some embodiments of the invention, the acknowledgement messages are received at least 10 minutes after the transmission of the encrypted block is completed. Possibly, the at least one of the receivers provided with the decryption keys before transmitting the encrypted block are selected at least partially responsive to previous behavior of the receivers. Optionally, the method includes broadcasting in at least one cell, one or more decryption keys of the encrypted block as multicast in the cell, wherein the broadcast decryption keys are encrypted using decryption keys of the block as multicast in one or more other cells.

Optionally, the at least one of the receivers provided with the decryption keys before transmitting the encrypted block are selected at least partially responsive to the number or percentage of acknowledgements provided by the receivers in a given period. Optionally, the at least one receivers provided with the decryption keys before transmitting the encrypted block are selected at least partially randomly. Optionally, the at least one receivers provided with the decryption keys before transmitting the encrypted block include all the receivers serviced by at least one base station. Optionally, the number of receivers provided with the decryption keys before transmitting the encrypted block is determined at least partially responsive to the total number of receivers expected to receive the encrypted block. Possibly, providing the one or more keys comprises providing by a secure key generator attached to the mobile station.

### BRIEF DESCRIPTION OF FIGURES

Particular non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 1 is a schematic illustration of a cellular network, in accordance with an exemplary embodiment of the present invention;

FIG. 2 is a flowchart of acts performed by a mobile station in receiving a file, in accordance with an exemplary embodiment of the invention; and

FIG. 3 is a schematic illustration of a cellular network, in accordance with another exemplary embodiment of the present invention.

### DETAILED DESCRIPTION OF EMBODIMENTS

System

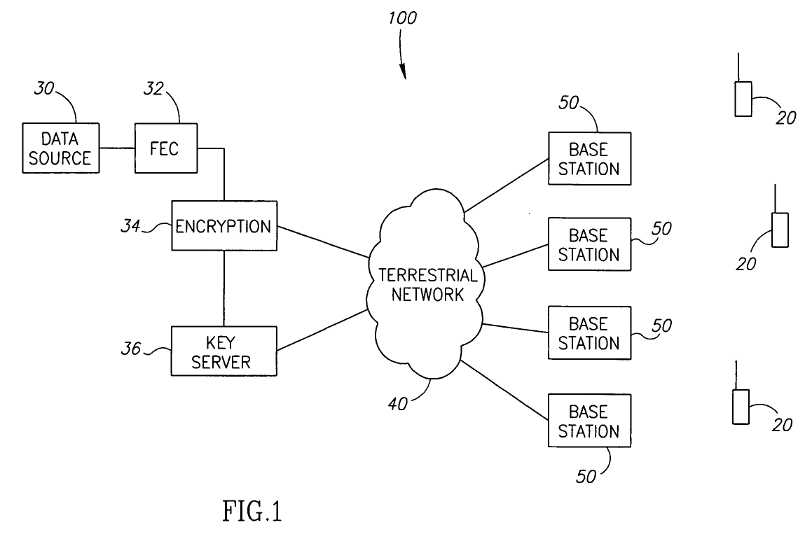

FIG. 1 is a schematic illustration of a cellular network 100, in accordance with an exemplary embodiment of the present invention. Network 100 includes a plurality of base stations 50, which transmit signals to mobile stations 20 in their vicinity. In transmission of multicast data to mobile stations 20, a data source 30 generates files which are to be multicast to subscribing mobile units 20. Optionally, the generated files are broken into blocks of predetermined size, suitable for processing. The blocks are optionally passed to a forward error correction (FEC) unit 32, where a plurality of segments are prepared to represent the block. Optionally, N segments are prepared, such that any M (M<N) of the N segments can be used to reconstruct the block. In some embodiments of the invention, a FEC which allows reconstruction with fewer than M segments with a given chance, is used. For example, the FEC may allow a 90% chance or block reconstruction with M-2 segments, 94% chance of reconstruction with M-1 segments and 100% chance of reconstruction with M segments. In some embodiments of the invention, each block requires at least 10 or even at least 20 segments for reconstruction. Possibly, at least 50 segments are required for reconstruction.

The FEC segments may be generated using substantially any FEC method known in the art, including one-dimensional, two-dimensional, systematic and non-systematic methods. In an exemplary embodiment of the invention, a FEC method such as described in PCT patent application PCT/IL2004/000204, filed Mar. 3, 2004 in PCT patent application PCT/IL2004/000805, published as WO, 2005/025106 and/or in Israel patent application 157,885, titled “Iterative Forward Error Correction”, filed Sep. 11, 2003, the disclosures of all of which are incorporated herein by reference, is used. The FEC segments are optionally transferred to an encryption unit 34, which encrypts the FEC segments, forming respective encrypted segments.

The encrypted segments of each base station 50 are optionally transferred through a terrestrial network 40 of cellular network 100 to their intended base station, from which they are transmitted to mobile stations 20. Base stations 50 operate as multicast transmission points from which transmitted segments of the same data are all identical. The segments from data source 30 to base stations 50 may be different for different segments although they carry the same data. The segments are transmitted to mobile stations 20 using any multicast method known in the art, such as the method described in PCT publication W003/019840 published Mar. 6, 2003, the disclosure of which is incorporated herein by reference. Optionally, each encrypted segment is transmitted as a respective RLC segment using methods known in the art.

Network 100 optionally includes a key server 36 which provides decryption keys to mobile stations 50. In some embodiments of the invention, users receiving the block (or the entire file), desiring to read the block, contact key server 36 and request the one or more keys they need for the decryption. Alternatively or additionally, when a plurality of keys are required, some of the keys are provided in multicast, and the users request only the keys that they need which were not multicast to them.

Base Station Key Diversity

In some embodiments of the invention, for each base station 50 or group of base stations, encryption unit 34 prepares differently encrypted segments, using one or more keys. The one or more keys of each unit are different from the keys used in the encryption of the segments for the other base stations.

The keys of different areas (e.g., base stations or groups of base stations) optionally are not derivable from a single seed using public information, such that keys or seeds provided to a user in one area cannot be used by users in other areas. The keys of the different areas are optionally generated independently from each other.

Optionally, each base station 50 uses different encryption keys. Alternatively or additionally, some base stations 50 use the same keys or use partially overlapping groups of keys, in order to limit the number of keys managed by encryption unit 34. Optionally, base stations 50 separated by large distances use the same keys or a partial group of overlapping keys. Alternatively or additionally, base stations 50 generally having small numbers of users use keys which are also used by other base stations. Further alternatively or additionally, all base stations 50 in a same region and/or controlled by a same controller, e.g., a same point-to-multipoint unit PTMU (introduced below) and/or base station controller (BSC), use the same keys.

Optionally, the size of a region of base stations 50 that use the same keys (or key) is selected such that a moving mobile station 20 will not pass through more than a predetermined number (e.g., 10-20) of regions having different keys, so as to limit the number of keys that moving mobile stations 20 need to request. In some embodiments of the invention, when a region uses more than one key for a single file, the total number of keys that a moving receiver will need to request is limited to less than a predetermined number of keys (e.g., less than 20, 30 or 50). Optionally, the sizes of the regions that have the same keys depend on the expected movement speed of the mobile stations 20. For areas in which fast movement is allowed through a large number of cells (i.e., areas governed by respective base stations), the number of neighboring base stations sharing common keys, in a single key region, is relatively large (e.g., greater than 10-20). Conversely, in regions in which movement is relatively slow and/or cells are relatively large, the number of cells sharing keys is relatively small (e.g., smaller than 10 or even 6).

Alternatively to sharing keys by neighboring cells, the cells that share keys are close cells that are separated by one or more intervening cells. Thus, a moving receiver does not need many keys, but neighboring receivers cannot necessarily use the same keys.

In some embodiments of the invention, base stations sharing keys share all their keys. Alternatively or additionally, some or all base stations that share keys share only some of their keys. In some embodiments of the invention, some or all of the base stations 50 randomly drop some of the segments they transmit, in order to induce diversity in the keys that the mobile stations 20 require in order to decrypt the data block.

Base Station Grouping

The base stations 50 that share keys may be predetermined groups of base stations. Alternatively, in order to make unauthorized dissemination of keys more difficult, the grouping of the base stations using same keys varies in real time. In some embodiments of the invention, the base station grouping varies every few hours or days. Alternatively, the base station groupings change every few moments and/or for every transmitted message or for every small number (e.g., up to 5-10) of messages. Further alternatively or additionally, the base station groupings may be changed within the transmission of a single message.

The number of groups in an entire network may be small, e.g., less than 20 or even less than 10, or may be large, e.g., more than 30, more than 50, more than 100 or even more than 500.

In some embodiments of the invention, the grouping of the base stations is changed randomly or in a pseudo random manner in order to prevent hackers from determining the grouping patterns. Alternatively or additionally, the grouping is adjusted according to the load on the network. Optionally, when the network is relatively loaded, fewer keys are used, for example having adjacent base stations use the same keys. This reduces the amount of bandwidth required for disseminating the keys and for providing the data to the base stations. When the network is relatively not loaded, more keys are used, to allow for better protection of the data. Alternatively or additionally, the local diversity of encryption keys between regions is configurable by a network operator.

Each base station 50 optionally uses a plurality of different keys for the segments of a single block. The number of keys used in encrypting the data of a single block for a single base station 50 is optionally determined as a compromise between using a large number of keys required for key diversity which prevents illegitimate dissemination of keys and a small number of keys, which reduces the amount of bandwidth spent on dissemination of keys to users. In an exemplary embodiment of the invention, a different key is used for about every 10-20 segments. Optionally, segments that are encrypted with the same key include sequential portions of data from the block. This option reduces the number of keys a user requires on the average. Therefore, users requiring a large number of keys raise more suspicion that they disseminate keys to others. Alternatively, segments encrypted with the same key are taken from separated portions of the block such that the segments encrypted with a single key are interleaved between segments encrypted with other keys.

The data transmitted in the different key regions is optionally transmitted substantially concurrently, within less than 15 minutes between the transmissions. In some embodiments of the invention, the transmissions in the different key regions are even more closely correlated in time, for example with less than 2 minutes or even less than half a minute between the transmissions in the different cells.

Key Differentiation Over Time

In some cases, some or all of the data segments of the block are transmitted a plurality of times in order to ensure proper reception, for example when mobile stations 20 may tune onto the channel at different times. Optionally, each time the segments are transmitted they are encrypted with different keys.

Packet Headers

In some embodiments of the invention, each transmitted segment includes a header which states the block and/or file to which it belongs, the position of the segment in a FEC array representing the block and an ID of the key required for decryption. The header is optionally not encrypted, so that the receiver can determine which segments are duplicates and can be discarded, whether a sufficient number of segments were received for reconstruction of the block and which keys are required for decrypting the segments. Alternatively or additionally, the segments are included in larger packets, for example IP packets, and the control information of the segment is included in a control section of the IP packet including the segment.

Optionally, the segment headers also include general information on the FEC method and/or encryption method. Alternatively or additionally, the general information is provided in the IP packets and/or at the beginning of the multicast. Further alternatively or additionally, the general information is provided on a separate channel, such as a broadcast channel describing the available multicast data and/or on a separate unicast channel used to provide the keys or for providing data at the beginning of the transmission.

System Layout

Although data source 30, FEC unit 32, encryption unit 34 and key server 36 are shown as separate units, in some embodiments of the invention, one or more of these units are implemented by a single entity. For example, encryption unit 34 and key server 36 may be implemented on a single processor and/or may use a common key database. In some embodiments of the invention, data source 30 performs the task of FEC unit 32 and/or encryption unit 34 before forwarding the packets. In other embodiments of the invention, the encryption is performed at base stations 50 or at processors associated with each of the base stations. For example, the encryption may be performed at point to multi-point units (PTMUs) of the base stations, which PTMUs are described in the above mentioned PCT patent application PCT/IL2004/000204. Optionally, in these embodiments, the encryption ID is generated by each base station and/or PTMU from a static (i.e., changes infrequently if at all) code of the base station and a time dependent code which may be common to all base stations or is generated separately for each base station. Optionally, the static code is kept secret from the users, to make it harder on users to guess the encryption keys.

In some embodiments of the invention, two or more of the entities of network 100, for example encryption unit 34 and base stations 50, have the ability to encrypt the segments. The unit that actually performs the encryption at any specific time optionally depends on the available processing resources on the units. For example, when the base stations are very loaded, the encryption is optionally performed by encryption unit 34.

Mobile Station Acts

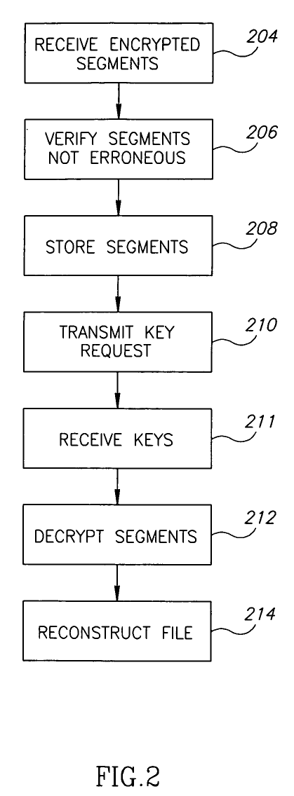

FIG. 2 is a flowchart of acts performed by a mobile station in receiving a file, in accordance with an exemplary embodiment of the invention. The mobile station optionally tunes onto a multicast channel and receives (204) encrypted segments. The mobile station optionally verifies (206) that the packets were received without error. For example, the segments may include a CRC field, the value of which is used to check that the segment was received intact. The CRC check may be performed by an application layer performing the decryption and reconstruction or by a lower protocol layer. Segments that were received without error are optionally stored (208) in a memory of the mobile station. When a group of segments sufficient to allow reconstruction of a block is accumulated, the mobile station transmits (210) a message to key server 36, with IDs of the keys (or key) it requires in order to decrypt the segments it received. Optionally, the receiver knows that a sufficient number of packets were received when a predetermined number of packets sufficient for reconstruction were received. Alternatively, the receiver simulates the reconstruction, without actually performing the reconstruction, which cannot be performed without the keys, in order to determine whether a sufficient number of packets were received. The simulations are optionally performed as described in the above mentioned Israel patent application 157,885, in PCT patent application PCT/IL2004/000805 and/or in PCT patent application PCT/IL2004/000204.

Key server 36 transmits the keys generally on a unicast transmission, to the mobile station (211), which uses the keys to decrypt (212) the segments. Optionally, the keys are transmitted in a compressed format. The block is then reconstructed (214) from the decrypted segments according to the FEC method used.

In some embodiments of the invention, in storing (208) the received segments, the mobile unit discards segments carrying the same data (even if the segments were encrypted with a different encryption). Optionally, in any case a duplicate segment is received, the later received segment is discarded. Alternatively, if one of the duplicate segments can be opened with the same key as a different segment already received, the other copy of the duplicate segment is discarded. In some embodiments of the invention, a user not receiving a sufficient number of multicast segments required for reconstruction during the multicast transmission may request supplement of data on a unicast link, for example along with requesting the keys.

Tracking Requesting Keys

Key server 36 optionally keeps track of the mobile stations requesting keys, for billing purposes. In some embodiments of the invention, key server 36 keeps special track of mobile stations that request particularly large sets of keys. Optionally, the content provider checks users that persistently, for many files, request large numbers of keys, to determine if they disseminate the keys to other users who are not being billed. In an exemplary embodiment of the invention, each file is transmitted 3-5 times with a 40-100% redundancy. In accordance with this exemplary embodiment, a request for about 25-30% of the keys is considered reasonable.

Alternatively or additionally to checking the number of keys requested, key server 36 checks whether there is a possibility that the requesting mobile station actually needs all the keys requested by the mobile station. For example, a mobile station 20 requesting keys belonging to packets transmitted in locations separated by a distance which cannot be traveled during the entire transmission time of the file would be considered suspicious. In some embodiments of the invention, when a mobile station requests two keys which can only be used for the same segment (with different encryption) the reason for this suspicious request is enquired.

In some embodiments of the invention, keys are shared by no more than 6, 4 or even 2 segments, such that the receivers are expected not to require a substantial number of the keys. In an exemplary embodiment of the invention, each transmitted packet has a separate key. When key server 36 determines that a receiver is requesting a key belonging to a specific FEC row or column for which a number of keys required to decode the row or column was already provided, the request is optionally considered suspicious. Alternatively or additionally, a request for more keys than the number of segments required to decode the file is considered suspicious.

In some embodiments of the invention, for a specific file, key server 36 provides up to a maximal number of keys which could be required to decode the file and keys beyond the maximal number are not provided. Keys are optionally not provided in other cases of suspicion. Alternatively, when a suspicious request for keys is received, the keys are provided but an alarm message is sent to a controller of network 100. Alternatively or additionally, a periodic report on suspicious key requests is initiated. In some embodiments of the invention, location data on the mobile station initiating the suspicious request for keys is determined.

Key IDs

In some embodiments of the invention, the key IDs associated with the segments used in requesting the keys from key server 36, are not allocated in any consecutive order, but rather are selected randomly. This makes it harder to request keys for segments that the user did not receive, in order to disseminate the keys to other users who do not pay for the keys. Optionally, the key IDs have a length which is sufficient to allow use of only some of the possible values in the keys, so as to make it more difficult for users to guess key IDs. Optionally, a manager of the network follows up on users that request non-existing keys. The length of the key ID field is optionally selected as a compromise between a long length which reduces the chances of illegal key dissemination and a short length which reduces the bandwidth required for key IDs. In an exemplary embodiment of the invention, the segment headers add an overhead of about 1-2%.

Alternatively to a single number serving as the key ID, the key ID may be formed of a plurality of fields, such as a first field identifying the base station 50 and a second field identifying the specific key used for the specific segment.

In some embodiments of the invention, different key IDs are used to represent the same key. This gives the advantage of using less bandwidth for providing the keys, while not allowing the subscribers to know before asking for the keys that the keys are the same. For example, different cells (or key regions) may use different key IDs for same keys used in common by the cells.

Optionally, mobile stations do not request (210) any keys unless they received sufficient data to allow reconstruction of the block. Thus, the mobile station is not billed for the block or for a file unless the block was received in a manner which allows reconstruction. This prevents billing mobile stations for data they could not reconstruct, for example due to an interference in communications between the base station and the mobile station in the middle of multicast data reception.

Alternatively to transmitting (211) all the required keys to the mobile station after all the data was received by the mobile stations, some or all of the keys are provided before the multicast transmission and/or along with the multicast transmission. In some embodiments of the invention, some of the keys are provided in a multicast transmission.

Local Generation of Keys

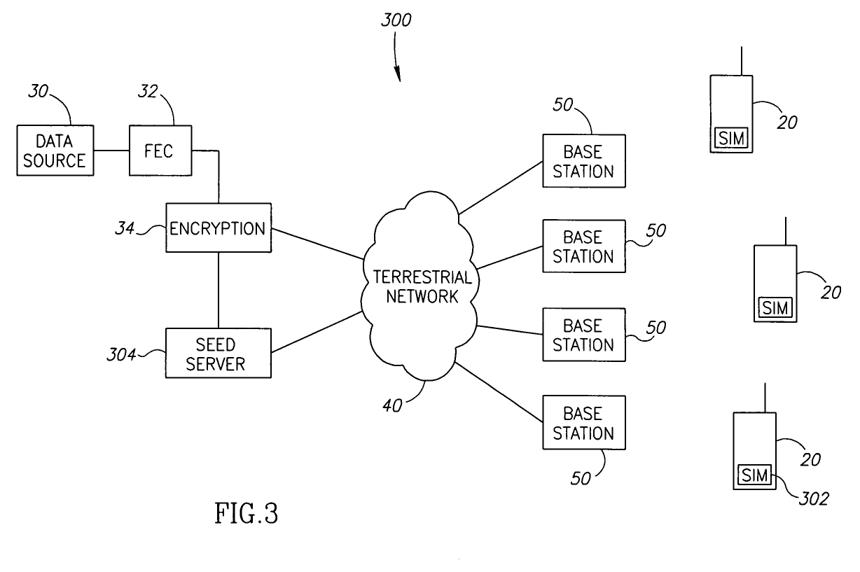

FIG. 3 is a schematic illustration of a cellular network 300, in accordance with an exemplary embodiment of the present invention. In the embodiment of FIG. 3, instead of the keys being transmitted to the receiver from a remote unit, such as key server 36 (FIG. 1), the keys are generated by a local key generator 302 located on the receiver, for example on a secure SIM card or other secure unit. While the remote unit is generally separated from the mobile station 20 by more than 10 meters, or even 50 meters and possibly communicates with the mobile station over a wireless connection, local key generator 302 is optionally within the same housing as mobile station 20 and/or communicates with the mobile station 20 over wires. Possibly, local key generator 302 communicates with the mobile station over a short range transmission method, for example having a range of less than 50, 10 or even 5 meters.

Optionally, a remote seed server 304 provides the local key generator 302 with a seed used in generating the keys. In an exemplary embodiment of the invention, a single seed or a small number of seeds (e.g., less than 20, less than 10 or even not more than 5) are used for generating more than 50, 100 or even a thousand keys. Thus, each segment can require a different key for deciphering, while not requiring transmission of all the keys from remote seed server 304. Optionally, each data segment has a header which identifies a key number (and possibly a corresponding seed number) from a set of keys generated responsive to the seed. The key numbers (and the optional seed number) of the segments are provided to the local key generator 302 which requests (or previously received) the seed from remote seed server 304 and responsive thereto provides the required keys. The local key generator 302 optionally provides only up to a maximal number of keys required for deciphering the received data block, for example according to a specific FEC used or any other of the embodiments discussed above in the section on tracking the requesting of keys, and does not provide more keys than required.

Optionally, the seed (or seeds) used by local key generator 302 is provided by remote seed server 304 using any of the methods suggested above for providing keys by key server 36.

In some embodiments of the invention, the seeds are provided only after the data block is provided to mobile station 20. Alternatively, seeds are not required by key generator 302 in generating the keys and seed server 304 is not used.

Multiple Levels of Keys

In some embodiments of the invention, the keys used in decrypting the data are provided to the receiver unencrypted. Alternatively, the keys used in decrypting the data, referred to herein as traffic keys (TK), are provided encrypted by one or more secondary keys (SK). In accordance with some of these embodiments of the invention, the traffic keys are provided to mobile stations 20 after the data block is received, as discussed above. The secondary keys, are provided at any convenient time, for example separately from the data and the traffic keys (e.g., on one or more unicast channels), with the traffic keys or with the data. Optionally, the secondary keys are provided before the traffic keys and are available immediately when the traffic keys are received.

In other embodiments of the invention, the secondary keys are provided to mobile stations 20 after the data block is received, as discussed above. The traffic keys are provided at any convenient time, for example with the data. Possibly, the traffic keys are provided in multicast before, after or during the transmission of the data block. In some embodiments of the invention, the traffic keys are transmitted on a separate channel from the data, in order to allow for different encryption areas (areas in which different encryption keys or schemes are used) of the traffic keys from the encryption areas of the data.

In still other embodiments of the invention, both the secondary keys and the traffic keys are provided to mobile stations 20 only after the data block is received by the mobile station.

Multiple levels of keys may be used with any of the above described embodiments, including those described above with reference to FIGS. 1 and 3.

In some embodiments of the invention, in accordance with FIG. 3, the secondary keys are provided to the local key generator 302 which decrypts the traffic keys for the receiver. If local key generator 302 is on a secure SIM card or other secure unit, the user of the receiver does not have access to the secondary keys and cannot pass them on to other users.

The traffic keys optionally change at a rate greater than the rate of change of secondary keys. In an exemplary embodiment of the invention, the traffic keys change at least every minute, or even at least every half minute. The secondary keys optionally change at a rate of less than every 15 minutes, less than every hour or even less than once a day. In some embodiments of the invention, the traffic keys or the secondary keys do not change at all.

Optionally, both the traffic keys and the secondary keys vary between geographical areas. In some embodiments of the invention, the areas having same traffic keys and the areas having same secondary keys completely overlap. Alternatively, the areas using same traffic keys are different from the areas in which same secondary keys are used. Optionally, for example, in accordance with this alternative, the traffic keys are transmitted on separate channels from the data. It is noted, however, that in some embodiments of the invention, only the secondary keys or only the traffic keys vary between geographical regions. In still other embodiments, neither the traffic keys nor the secondary keys vary between geographical areas.

Advertising Keys of Neighboring Key Regions

Some or all of the base stations 50 optionally advertise the secondary keys of their neighboring regions encrypted by the secondary key of the current cell, so that mobile stations 20 having the secondary key of the current key region will also have the secondary keys of the neighboring key regions. Upon moving to a neighboring key region, mobile stations 20 will not need to acquire, and the system will not need to specially rebroadcast, the secondary key of the new key region.

In some embodiments of the invention, the advertisement of the secondary keys of the neighboring key regions is performed by transmitting the keys on a broadcast channel of the key region. Alternatively or additionally, the keys of the neighboring regions are annexed to the data of the multicast. Optionally, the advertisement of the keys of the neighboring regions is performed periodically, for example at least every minute or at least every hour.

Alternatively to encrypting the secondary keys of the neighboring region with the secondary key of the current key region, the keys of the neighboring regions are encrypted using a different key. In some embodiments of the invention, the keys of the neighboring cells are encrypted using a key formed from the secondary key of the current region and a trust key which designates the level of trust in the mobile station 20. Optionally, only mobile stations 20 considered trustworthy are given the trust key, such that other mobile stations 20 will have to collect the secondary key of each region upon entering the region.

In some embodiments of the invention, alternatively or additionally to transmitting the keys of the neighboring regions encrypted by the key of the current region, one or more of the regions transmits its current secondary keys encrypted by the secondary keys of neighboring regions. Thus, immediately upon entering a key region from a neighboring region, the secondary key of the region can be acquired.

Alternatively or additionally to advertising secondary keys of neighboring regions, the traffic keys of neighboring regions are advertised.

Encryption Method

The implementation of the present invention allows using relatively simple encryption methods, since in order to reconstruct a file the receiver needs to break the code for a plurality of different keys. In addition, even if a subscriber succeeds in breaking the code and determining the keys for the data it received, most other users cannot reconstruct the file using these keys as they need other keys. In some embodiments of the invention, the encryption method used is sufficiently complex to prevent breaking of the code by small processors, such as hosted by mobile stations 20, but which may be breakable by stronger processors not usually hosted by mobile units. In some embodiments of the invention, the encryption is performed using a single key for both encryption and decryption. Encryption schemes using a single key for encryption and decryption require less processing resources for decryption, than public-private schemes, so that the battery of the mobile units is not drained out too fast.

Optionally, the encryption is performed in accordance with a polynomial encryption method. Alternatively or additionally, the encryption is performed using a low density parity code (LDPC) such as the Tornado code. Alternatively, the encryption is performed using a public/private key scheme. In some embodiments of the invention, when it is desired to minimize the processing power spent on decryption, a low-complexity encryption scheme is used. For example, a streaming encryption scheme based on generator polynomials may be used.

It is noted that when the channel between base stations 50 and mobile stations 20 has a high loss rate, for example, due to high noise levels and/or late tuning of mobile stations 20 onto the channel, the chances of several mobile stations 20 requiring exactly the same keys is very small. Optionally, the number of keys used is set such that on the average no more than 5-10 users require the same keys. Alternatively or additionally, the number of keys used is selected such that, on the average, in each cell no more than 5-10% of the receivers require the same keys. Further alternatively or additionally, the number of keys used is selected, such that no more than 0.1-1% of the receivers in the network, on the average, require the same set of keys. Further alternatively or additionally, the number of keys used is adjusted according to the importance of the encrypted data.

In some embodiments of the invention, the size of the FEC block used is selected according to the loss rate of the channel, so that the chances of two users requiring the same keys is small. For lower loss rates, users optionally need a larger number of segments.

In the above description, the same encryption methods are used for all the base stations at all times, but with different keys. Alternatively, the encryption methods are varied from time to time in order to make the breaking of the code more difficult. In some embodiments of the invention, each mobile station 20 optionally has software that can decrypt a plurality of different codes. Along with each key received from key server 36, the receiver is optionally provided with identification of a decryption method to be used with the key.

Alternatively to encrypting segments of the same size as the FEC segments, the encryption may be performed on smaller segments. In some embodiments of the invention, the encryption segments do not range over the border between two FEC segments, so that an error in a transmitted encryption segment affects only a single FEC segment.

In an exemplary embodiment of the invention, the DES encryption algorithm is used. The DES encryption algorithm operates on encryption segments of 8 bytes. Optionally, the FEC segments are larger than the encryption segments, for example including 30 bytes in each segment. In some embodiments of the invention, each FEC segment is broken into four portions: three encrypted segments of 8 bytes each, and a non-encrypted segment of 6 bytes.

In some embodiments of the invention, the non-encrypted bytes are located in the same positions of the FEC segments, such that the receivers can determine 20% of the data without decryption. Optionally, these embodiments are used when 20% of the data file cannot be used without the rest of the data. Alternatively or additionally, at least some of the 20% of the data is used to transfer previews, ads and/or other data which is to be supplied to the users for free. Alternatively, the non-encrypted bytes are positioned at different positions in the FEC segments for different FEC segments. Using a substantially even distribution, each position carries 80% encrypted data and 20% unencrypted data. Thus, for each position, a receiver without encryption keys has at most 20% of the data, if no data is lost. This alternative is optionally used when it is not possible to reconstruct the file only with the unencrypted data. It is noted that although the above discussion uses specific numbers for the unencrypted portion, the principals of the invention may be used also for other ratios between encrypted and non-encrypted data in the FEC segments.

Although the above description relates to using FEC segments, the present invention may be used with other redundancy methods, such as duplication and/or repeated transmission on different channels and/or in different locations.

The above description relates to base stations that serve as multicast transmission points. It is noted that the present invention may be used in substantially any multi-transmission-point network, such as cellular networks, cable networks and wireless local area networks (WLAN) (in which the transmission points are access points). It is noted that the present invention may be used also in networks that have a plurality of different types of multicast transmission points. Furthermore, the present invention may be used with one or more transmission points that transmit signals on a plurality of different channels (e.g., frequency or code channels), each of the channels defining a separate respective cell. In some embodiments of the invention, the multi-transmission-point network has a central controller which manages all registrations to the network. Alternatively or additionally, receivers of the multi-transmission-point network automatically tune to the network in moving between regions.

While in some embodiments described above the term data block was used to relate to an amount of data that is represented by a plurality of FEC segments, the term is not necessarily limited to any specific amount of data and may cover very large (e.g., more than 1 Mbyte) and very small (e.g., 2 bytes) blocks of data.

The above methods of secure transmission may be used alone or in conjunction with other methods of secure transmission, such as any of the methods and/or using any of the apparatus described in EP patent application Ser. No. 0994600, titled “Method and Apparatus for a Secure Multicast Transmission”, the disclosure of which is incorporated herein by reference.

It will be appreciated that the above described methods may be varied in many ways, including, changing the order of steps, and the exact implementation used. For example, although the transmitted data blocks are mentioned as being parts of transmitted files, they may also be parts of continuous data streams. The methods of the present invention may be performed in various protocol layers and may be performed for a single transmission system in a plurality of communication protocol layers. It should also be appreciated that the above described methods and apparatus are to be interpreted as including apparatus for carrying out the methods and methods of using the apparatus.

The present invention has been described using non-limiting detailed descriptions of embodiments thereof that are provided by way of example and are not intended to limit the scope of the invention. For example, different keys may be used only for different base stations without changing the keys for different segments of the same block from a same base station. Thus, the bandwidth required for key dissemination is small while risking a local illegal dissemination of keys. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A method of disseminating keys for decryption, comprising:
registering a plurality of receivers as clients of a multicast service of data; and
providing each receiver with one or more keys required for utilizing the data of the multicast service, responsive to a location of the receiver, such that at least two receivers are provided with different keys.

2. A method according to claim 1, wherein the different keys provided to the at least two receivers enable usage of the same data content by all of the at least two receivers.

3. A method according to claim 1, comprising determining for each receiver a parameter of a location in which the receiver is located and wherein providing the keys comprises providing responsive to the parameter of the location of the receiver.

4. A method according to claim 3, wherein data encrypted with the provided keys is transmitted to the receivers in segments with key IDs that identify the keys to be used in their decryption and wherein determining the parameter of the location comprises receiving a key ID which is used only in one or more specific regions.

5. A method according to claim 1, wherein determining the parameter and providing the one or more keys responsive to the determined parameter comprises determining a base station to which the client is registered and transmitting the keys by the base station.

6. A method according to claim 1, wherein providing the one or more keys comprises providing secondary keys used in decrypting traffic keys which can be used to decrypt the data.

7. A method according to claim 6, comprising providing the traffic keys in multicast or broadcast.

8. A method according to claim 1, wherein providing the one or more keys comprises providing traffic keys of the data.

9. A method according to claim 1, wherein providing the one or more keys comprises providing different keys in at least ten different geographical regions.

10. A method according to claim 1, wherein the areas of regions in which different keys are provided change dynamically, such that keys provided in different areas at a same time may be the same at a first time point and different at a second time point.

11. A method according to claim 1, wherein providing the one or more keys comprises providing the keys after providing all the data for which the keys are to be used.

12. A method according to claim 1, wherein providing the one or more keys comprises providing in a broadcast.

13. A method according to claim 1, wherein the different keys require separate dissemination to users.

14. A method of multicasting data in a multi-transmission point network, comprising:
providing a data block for multicasting by the network;
encrypting at least a portion of the provided data block, for each of a plurality of transmission points of the multi-transmission-point network, using at least one decryption key, so as to generate one or more encrypted data units for each of the transmission points; and
transmitting the encrypted data units from their respective transmission points,
wherein the at least one decryption key of at least two of the transmission points are different and require separate dissemination to users.

15. A method according to claim 14, wherein encrypting so as to generate one or more encrypted data units comprises generating a plurality of segments that represent the data block and encrypting at least a portion of the generated segments.

16. A method according to claim 15, wherein at least some of the transmission points transmit data units representing identical segments encrypted using different keys.

17. A method according to claim 15, wherein generating the plurality of segments comprises generating such that a receiver needs to receive fewer than all the generated segments of a single transmission point in order to reconstruct the data block.

18. A method according to claim 17, wherein generating the plurality of segments comprises generating forward error correction (FEC) segments.

19. A method according to claim 17, wherein generating the FEC segments comprises generating such that any group of up to a predetermined number of non-identical segments can be used to reconstruct the data block.

20. A method according to claim 19, wherein the data units are generated such that a receiver can reconstruct the data block using segments received from two different multicast transmission points and encrypted using different keys.

21. A method according to claim 14, wherein transmitting the encrypted data units from their respective transmission points comprises transmitting at substantially the same time.

22. A method according to claim 14, wherein the at least one decryption key of at least two of the transmission points are not derivable from a common seed using only publicly available information.

23. A method according to claim 14, comprising receiving, from mobile stations, requests for decryption keys.

24. A method according to claim 23, wherein receiving the requests comprises receiving after transmitting the encrypted data units from their respective transmission points.

25. A method according to claim 14, wherein the data block comprises one or more traffic keys to be used in decrypting data.

26. A method according to claim 14, wherein the at least two of the transmission points using different keys that require separate dissemination to users comprise at least ten transmission points.

27. A method according to claim 14, wherein at least two of the transmission points use the same keys.

28. A method according to claim 27, wherein the transmission points included in a group that use same keys vary dynamically over time.

29. A method according to claim 28, wherein the transmission points included in a group that use same keys vary over time during transmission of data units representing a single data block.

30. A method according to claim 14, wherein at least one of the transmission points transmits data units of the same block encrypted using a plurality of different keys.

31. A method according to claim 14, wherein each transmitted data unit is encrypted with a different key.

32. A method according to claim 14, wherein transmitting the encrypted data units comprises transmitting on a lossy channel, having a loss rate of at least 10% of packets it carries.

33. A method according to claim 32, wherein encrypting at least a portion of the generated segments comprises encrypting with a sufficient number of keys, so that given a loss rate of the multicast channels, less than a predetermined percentage of receivers of the data block will be able to use, on the average, the same set of keys for decryption.

34. A method according to claim 33, wherein encrypting at least a portion of the generated segments comprises encrypting with a sufficient number of keys, so that given a loss rate of the multicast channels, less than ten percent of the receivers of the data block will be able to use on the average the same set of keys for decryption.

35. A method according to claim 14, comprising receiving requests for keys required for decryption and keeping track of receivers that request a suspiciously large number of keys or request keys corresponding to non-existent identifications.

36. A method according to claim 14, wherein substantially all the encryption for the plurality of transmission points is performed at a single location.

37. A method according to claim 14, wherein the encryption of different segments is performed by different units.

38. A method according to claim 14, comprising transmitting the at least one key of a first transmission point encrypted by a key of a second transmission point, through one of the transmission points.

39. A method according to claim 38, wherein transmitting the at least one key of the first transmission point encrypted by a key of a second transmission point comprises transmitting through the second transmission point.

40. A method according to claim 38, wherein transmitting the at least one key of the first transmission point encrypted by a key of a second transmission point comprises transmitting through the first transmission point.

41. A method according to claim 38, wherein transmitting the at least one key of the first transmission point comprises transmitting on a broadcast channel.

42. A method according to claim 38, wherein transmitting the at least one key of the first transmission point comprises transmitting through a first transmission point keys of a plurality of neighboring transmission points encrypted by the key of the first transmission point.

43. A method of receiving multicast data over a transmission network, by a mobile station, comprising:
receiving, by a data reception unit of a mobile station, a plurality of data units to be used in reconstructing a data block, from a plurality of transmission points of the network, at least two data units received through different transmission points being encrypted in a manner requiring different keys, for decryption;
receiving the different keys required for decrypting the at least two data units, from a unit separate from the data reception unit;
decrypting the at least two data units; and
reconstructing the data block using the decrypted data units.

44. A method according to claim 43, wherein receiving the keys required for decryption comprises receiving from a remote unit.

45. A method according to claim 43, wherein receiving the keys required for decryption comprises receiving from a secure unit coupled to the mobile station.

46. A method according to claim 43, wherein the different keys required by the at least two data units are not derivable from a same seed using publicly available information.

47. A method according to claim 43, wherein reconstructing comprises reconstructing in accordance with a forward error correction FEC scheme.

48. A method according to claim 43, comprising determining from the received data units identification of the keys required in order to decrypt the data units and requesting the required keys from a key server.

49. A method according to claim 48, wherein the identifications of the keys depend, at least partially, on the transmission point through which the data units are received, such that data units transmitted through different transmission points include different key identifications.

50. A method according to claim 43, wherein each of the data units used in reconstructing the data block is decrypted using a separate key.

51. A method of multicasting data, comprising:
providing a data block for multicasting;
generating a plurality of segments that represent the data block, such that a receiver needs to receive fewer than all the generated segments in order to reconstruct the data block;
encrypting at least a portion of the generated segments, so as to generate encrypted data units encrypted with a plurality of different keys, which require separate dissemination to users; and
transmitting the encrypted data units over one or more multicast channels.

52. A method according to claim 51, wherein transmitting the encrypted data units comprises transmitting over one or more multicast channels by a single transmitter.

53. A method according to claim 51, wherein the different keys are not derivable from a same seed using only public information.

54. A method according to claim 51, wherein each of the plurality of different keys is used for no more than three segments.

55. A method according to claim 54, wherein each segment is encrypted using a different key.

56. A mobile station, comprising:
a receiver adapted to receive data over a wireless connection; and
a processor adapted to accumulate a plurality of data units received through the receiver from a plurality of different transmission points, which data units include at least two data units received through different transmission points require different keys for decryption, and also adapted to receive the different keys required for decrypting the data units, to decrypt the at least two data units and to reconstruct the data block using the decrypted data units.

57. A mobile station according to claim 56, comprising a secure card, separate from the processor and having different ease of access by a user of the mobile station, which is adapted to provide the keys to the processor.

58. A method of managing key provision, comprising:
receiving, from a receiver, a request for keys required in order to decrypt encrypted segments of a plurality of segments representing a data block; and
checking whether there is a suspicion that the receiver will disseminate requested keys to other receivers.

59. A method according to claim 58, wherein the checking comprises checking whether there is a possibility that the requesting receiver actually needs all the requested keys in the request, for decrypting the data block.

60. A method according to claim 58, wherein the checking comprises checking whether the receiver requested for the data block more keys than the data block requires for decryption.

61. A method according to claim 58, wherein the checking comprises checking whether the receiver requested a suspiciously high number of keys.

62. A method according to claim 58, wherein the checking comprises checking whether the receiver requested keys relating to packets transmitted in locations separated by a distance which cannot normally be traveled on the ground during the entire transmission time of the data block.

63. A method according to claim 58, wherein the checking comprises checking whether the receiver requested two keys which can only be used for the same data segment with different encryption.

64. A method according to claim 58, wherein receiving the request comprises receiving by a secure unit coupled to the receiver.

65. A method according to claim 64, comprising not providing the requested keys if the check determined that there is no possibility that the requesting receiver actually needs the keys for the data block.

66. A method according to claim 58, wherein receiving the request comprises receiving by a unit external to the receiver.

67. A method according to claim 58, comprising not providing the requested keys if the check determined that there is no possibility that the requesting receiver actually needs the keys for the data block.
